(19) United States
(12) Patent Application Publication
(10) Pub. No.: US 2007/0199180 A1
(43) Pub. Date: Aug. 30, 2007

(54) FORKED SPRING TUBE

(76) Inventors: Chia-Hui Chen, Taoyuan (TW); Tien-Yueh Hsu, Taoyuan (TW)

Correspondence Address: SINORICA, LLC, 528 FALLSGROVE DRIVE, ROCKVILLE, MD, 20850, US

(21) Appl. No.: 11/625,895

(22) Filed: Jan. 23, 2007

(30) Foreign Application Priority Data
Feb. 24, 2006 (TW) 095203142

(51) Int. Cl. E05D 11/08

(52) U.S. Cl. 16/342

(57) ABSTRACT

A forked spring tube used for a pivot hinge on a foldable electronic product, it provides an elastic twisting force for a rotation axle. The forked spring tube has an annular slipping over portion for slipping over a shaft of the rotation axle, the slipping over portion is formed on its periphery a slit to be endued with elasticity, and the lower area of the slipping over portion has a positioning protruding sheet extending vertically downwards, the bottom of the positioning protruding sheet is formed to have a left and a right bevel portion as being forked from its middle; the two bevel portions mutually symmetrical are formed at their respective upper areas fulcrums, this will get larger fulcrum areas, and the twisting force that the spring tube can bear can be much increased; after the spring tube is assembled in a connecting portion of a fixing seat, it can be more even structurally than the prior art, and is not subjected to the problem of loosening.

### BACKGROUND OF THE INVENTION

1. Field of the invention

The present invention relates to a structure of a forked spring tube, and especially to a forked spring tube used for a pivot hinge on a foldable electronic product such as a notebook.

2. Description of the Prior Art

Referring to FIG. 1 which is a perspective view of a preferred spring tube used on a hinge, the spring tube has a slipping over portion 91 able to be slipped over a shaft of a rotation axle, the slipping over portion 91 is formed at an end thereof a slit 93 to provide an elastic twisting force when it is extended over the shaft of a rotation axle, a positioning protruding sheet 92 extends vertically down from the positioning protruding sheet 92, the bottom of the positioning protruding sheet 92 is provided at its middle with a protruding piece 94 functioning as a fulcrum of the spring tube; by assembling the positioning protruding sheet 92 and the protruding piece 94 in a connecting portion of a fixing seat, a positioning function for the spring tube can be obtained. The structure can be seen in the prior art as shown in U.S. Pat. No. 7,124,473 titled “HINGE FOR A NOTEBOOK COMPUTER” and U.S. Pat. No. 6,170,120 titled “NOTEBOOK COMPUTER HINGE”.

In such a conventional spring tube, designing of the protruding piece 94 as a fulcrum renders a surface perpendicular to the surfaces of the positioning protruding sheet 92 able to bear pressure, this can increase the value of twisting force that can be born by the entire spring tube. However, by virtue that the protruding piece 94 can only be provided on a lateral surface of the positioning protruding sheet 92, the surface has only a small contact area, and the twisting force it provides is limited; besides, the two lateral surfaces of the positioning protruding sheet 92 become asymmetrical, an action force on the spring tube will be uneven, this tends to have the phenomenon of loosening, and improvement is wanted.

### SUMMARY OF THE INVENTION

In view of the above stated defects of the conventional techniques, the present invention provides a spring tube having an annular slipping over portion for slipping over a shaft of a rotation axle, the annular slipping over portion is formed on its periphery a slit to be endued with elasticity, and the lower area of the annular slipping over portion has a positioning protruding sheet extending vertically downwards, the bottom of the positioning protruding sheet is formed to have a left and a right bevel portion as being forked from its middle; the two bevel portions mutually symmetrical are formed at their respective upper areas fulcrums, this will be better than the prior art in having larger fulcrum areas, and the twisting force that the spring tube can bear can be much increased; after the spring tube is assembled in a connecting portion of a fixing seat, it can be more even structurally than the prior art, and is not subjected to the problem of loosening.

Moreover, the present invention provides a hinge using the forked spring tube, the hinge has a fixing seat being composed of an assembling portion and a connecting portion, wherein the connecting portion is connected with a main body of a foldable electronic product, the assembling portion is provided with a fork-like hole in coincidence with the shape of the forked spring tube, the fork-like hole can be mounted therein with two forked spring tubes; the hinge further has a rotation axle having a connecting portion able to assemble with a foldable screen of the foldable electronic product and a shaft able to extend through two annular slipping over portions of the forked spring tubes. With the structure of the hinge, by enveloping of the annular slipping over portions of the forked spring tubes over the shaft of the rotation axle, the foldable screen can be opened and positioned at any desired angular position relative to a main body of the electronic product.

The present invention will be apparent in its structural features and the operational functions after reading the detailed description of the preferred embodiment thereof in reference to the accompanying drawings.

### BRIEF DESCRIPTION OF THE DRAWINGS

FIG. 1 is a perspective view showing a conventional spring tube having a fulcrum;

FIG. 2 is a perspective view showing a forked spring tube of the present invention;

FIG. 3 is a plane view of the forked spring tube of the present invention;

FIG. 4 is an anatomic perspective view showing the forked spring tube of the present invention used on a hinge;

FIG. 5 is a perspective view showing the forked spring tube of FIG. 4 after assembling;

FIG. 6 is an anatomic perspective view showing that the hinge using the forked spring tube of the present invention is applied to a foldable electronic product.

FIG. 7 is a perspective view showing the elements of FIG. 6 after assembling;

FIG. 8 is a sectional view taken from a sectional line A-A of FIG. 7;

FIG. 9 is a schematic developed view showing internal oil ducts in the annular slipping over portion of the forked spring tube of the present invention.

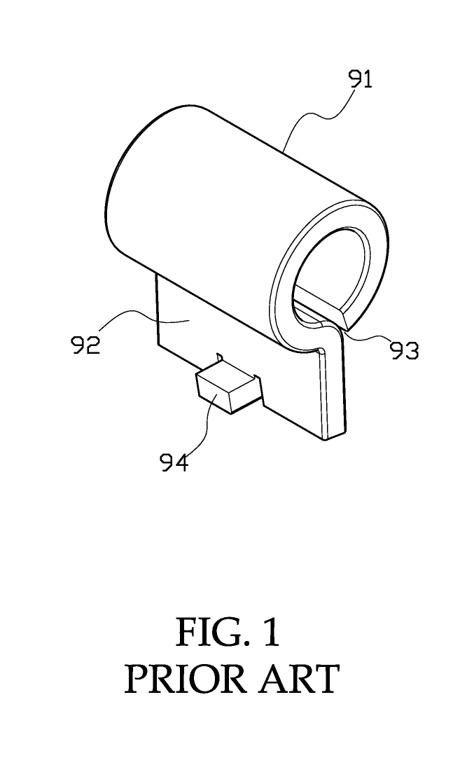

### DETAILED DESCRIPTION OF THE PREFERRED EMBODIMENT

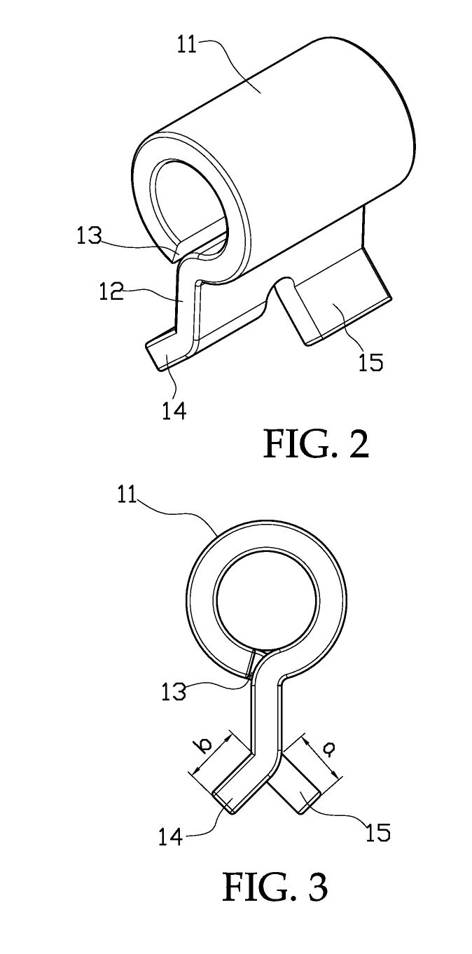

Referring to FIGS. 2 and 3, a forked spring tube 10 of the present invention has an annular slipping over portion 11 for slipping over a shaft of a rotation axle, the annular slipping over portion 11 is formed on the periphery thereof a slit 13 to endue the annular slipping over portion 11 with elasticity over the shaft of the rotation axle, the lower area of the annular slipping over portion 11 has a positioning protruding sheet 12 extending vertically downwards, the bottom of the positioning protruding sheet 12 is formed to have a left and a right bevel portion 14, 15 as being forked from its middle. Referring to FIG. 3, the two bevel portions 14, 15 are formed at their respective upper areas a, b fulcrums, this will be better than the prior art in having larger fulcrum areas, and the twisting force that the spring tube 10 can bear can be much increased; after the spring tube is assembled in a connecting portion of a fixing seat, by virtue that the two bevel portions 14, 15 are allocated mutually symmetrically at the two lateral sides of the positioning protruding sheet 12, the forked spring tube 10 can be more even structurally than the prior art, and is not subjected to the problem of loosening.

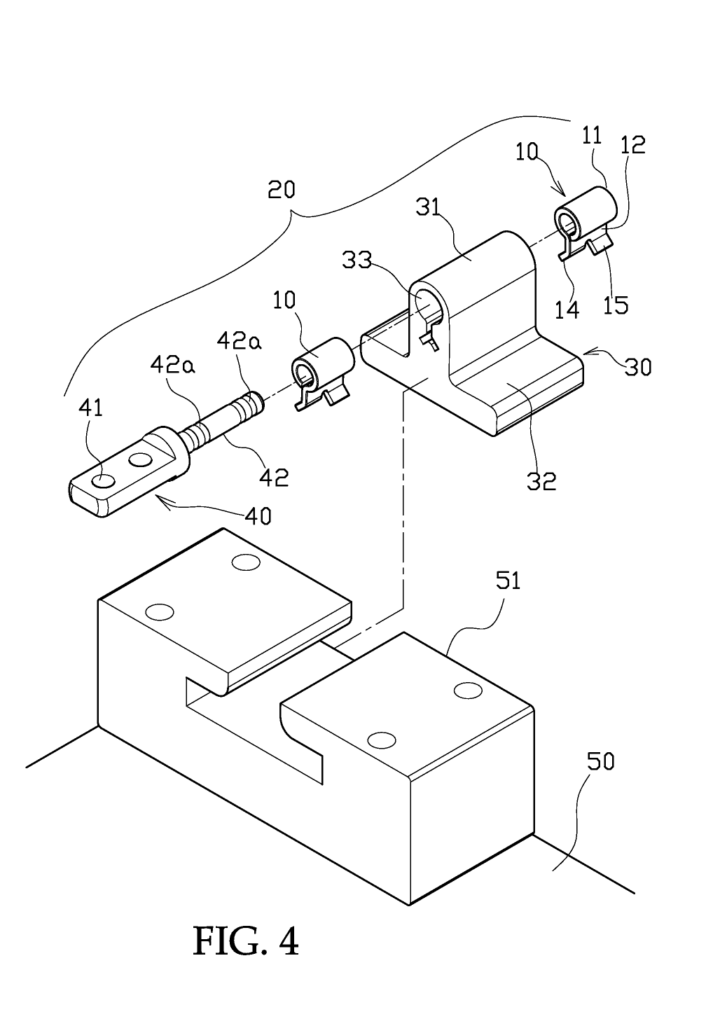

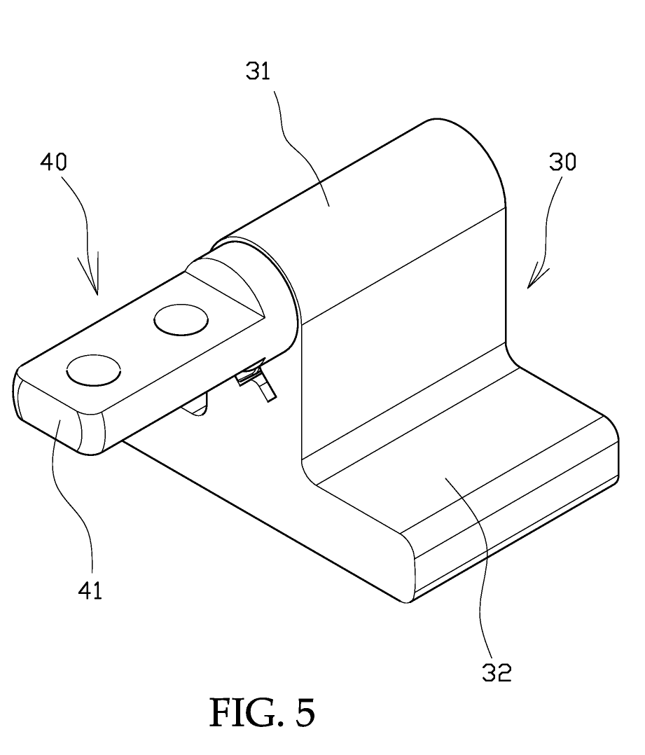

Moreover, referring to FIGS. 4 and 5 showing that a plurality of forked spring tubes 10 of the present invention are used on a hinge 20, the hinge 20 has a fixing seat 30 being composed of an assembling portion 31 and a connecting portion 32, wherein the connecting portion 32 is connected with a main body 50 of a foldable electronic product, the assembling portion 31 is provided therein with a fork-like hole 33 in coincidence with the shape of the forked spring tube 10, the fork-like hole 33 can be mounted therein with two forked spring tubes 10. The hinge 20 further has a rotation axle 40 having a connecting portion 41 which is connected with a main body of the foldable electronic product, a shaft 42 of the rotation axle 40 in opposition to the connecting portion 41 is extended into the two forked spring tubes 10 and the assembling portion 31; by tight enveloping of the two forked spring tubes 10 in the assembling portion 31 over the surface of the shaft 42, the rotation axle 40 can hold and position a foldable screen at any desired angular position relative to the main body 50 of the electronic product in an opened state. The shaft 42 of the rotation axle 40 can be provided with a plurality of oil ducts 42a to provide a lubricating function.

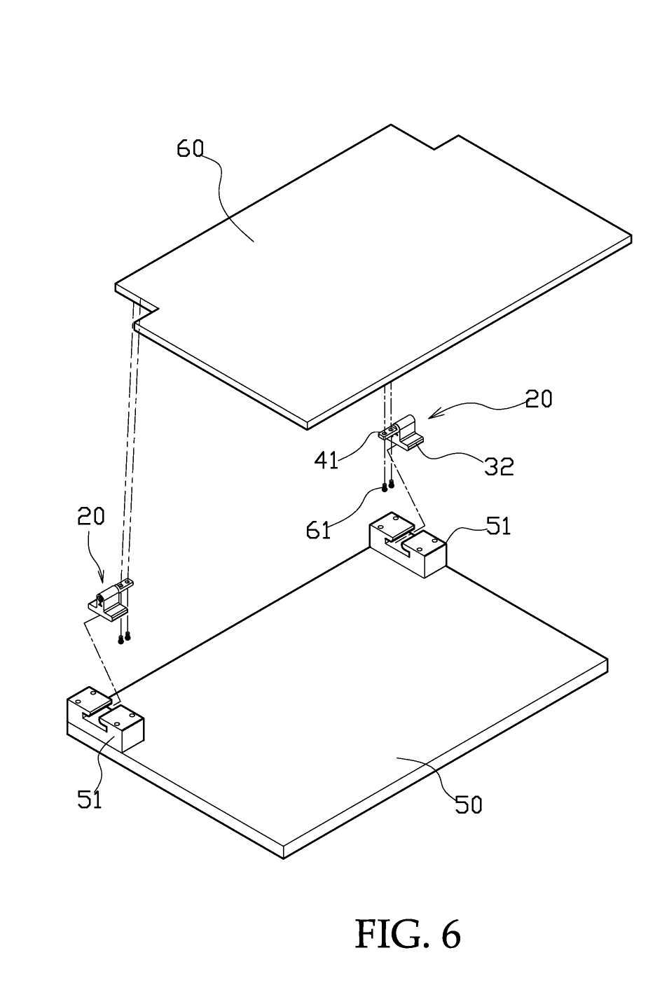

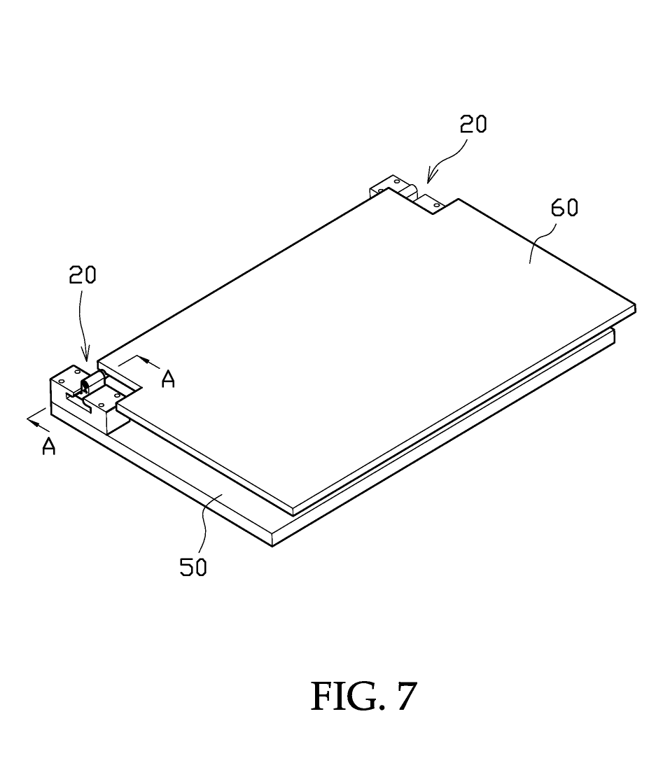

Referring to FIGS. 6 and 7 which shows that two hinges 20 are assembled between the main body 50 of the electronic product and a foldable screen 60, two connecting portions 32 of two fixing seats 30 of the two hinges 20 are assembled on two seats 51 of the main body 50, while two connecting portions 41 of two rotation axles 40 are locked onto the foldable screen 60.

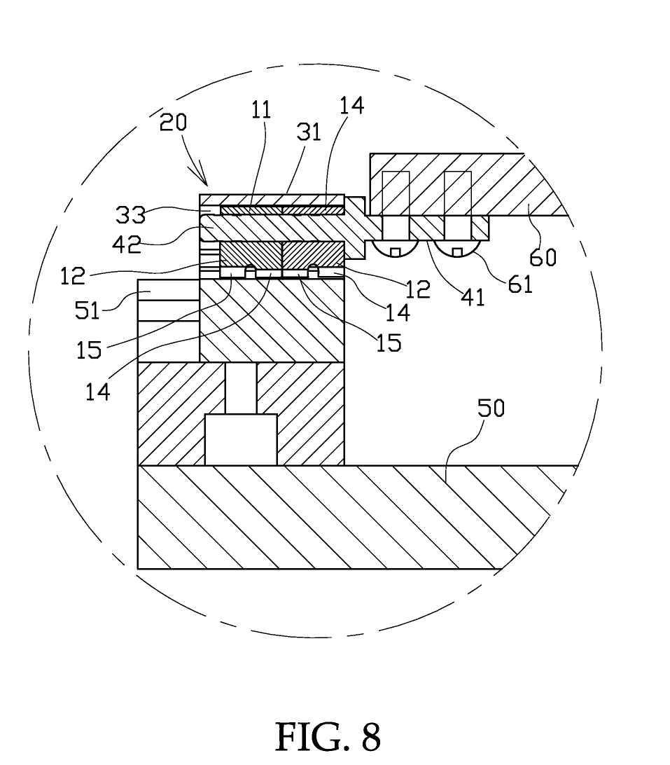

Referring to FIG. 8, it shows that a hinge 20 is connected between a foldable screen 60 and a main body 50. By virtue that two bevel portions 14, 15 allocated mutually symmetrically at lower areas with the function of fulcrum of two positioning protruding sheets 12 of two forked spring tubes 10 provide more fulcrum areas, this can increase the value of twisting force that can be born by the entire hinge 20 which can thus bear a heavier foldable screen 60; and by virtue that bevel portions 14, 15 allocated mutually symmetrically as to their respective positioning protruding sheets 12, the hinge 20 is not subjected to loosening, thus the entire structure can have a longer life of use.

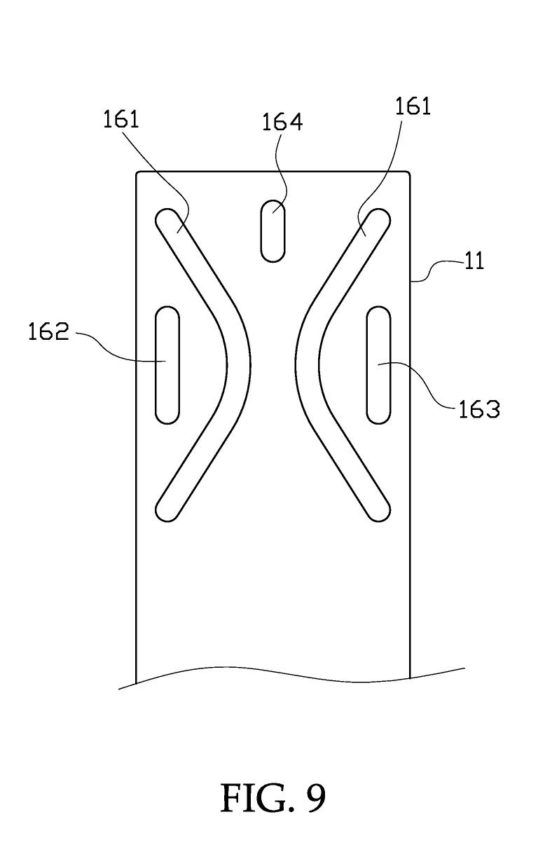

The annular slipping over portion 11 of each forked spring tube 10 of the present invention can be provided on its inner wall with a plurality of oil ducts, please refer to FIG. 9 which is a schematic developed view, the depth of each of the oil ducts is 0.1 mm; basically, the oil ducts 161 form an “X” shape, three short oil ducts 162, 163, 164 are provided respectively at the left side, the right side and an upper middle of the “X” shape. With this design of the “X” shape of the oil ducts 161, the shaft 42 of the rotation axle 40 can provide a better lubricating function.

What are shown in the drawings are only for illustrating the preferred embodiments of the present invention, and not for giving any limitation to the scope of the present invention. It will be apparent to those skilled in this art that various equivalent modifications or changes made without departing from the scope of this invention shall fall within the scope of the appended claims.

1. A forked spring tube used on a hinge, said hinge has at least a fixing seat and a rotation axle, said spring tube has an annular slipping over portion for slipping over a shaft of said rotation axle, said annular slipping over portion is formed on a periphery thereof a slit to endue said annular slipping over portion with elasticity over said shaft of said rotation axle, a lower area of said annular slipping over portion has a positioning protruding sheet extending vertically downwards, a bottom of said positioning protruding sheet is formed to have a left and a right bevel portion as being forked from its middle, said two bevel portions are formed at their respective upper areas fulcrums.

2. The forked spring tube used on a hinge as claimed in claim 1, wherein said annular slipping over portion is provided on its inner wall with a plurality of oil ducts.

3. The forked spring tube used on a hinge as claimed in claim 2, wherein said oil ducts provided on said inner wall of said annular slipping over portion basically are in an “X” shape, and three short oil ducts are provided respectively at a left side, a right side and an upper middle of said “X” shape.

4. A hinge with forked spring tubes, said hinge is assembled with a foldable screen of a foldable electronic product, said foldable electronic product has said foldable screen and a main body pivotally connected with each other, said hinge comprises:
a fixing seat being composed of an assembling portion and a connecting portion, wherein said connecting portion is connected with said main body of said foldable electronic product, said assembling portion is provided with a fork-like hole;
a rotation axle having a connecting portion to assemble with said foldable screen and a shaft extending into said fork-like hole of said fixing seat;
said forked spring tubes which are a pair in amount and are assembled in said fork-like hole of said fixing seat, each of said forked spring tubes has an annular slipping over portion for slipping over said shaft of said rotation axle, said annular slipping over portion is formed on its periphery a slit to be endued with elasticity, and a lower area of said annular slipping over portion has a positioning protruding sheet extending vertically downwards, a bottom of said positioning protruding sheet is formed to have a left and a right bevel portion as being forked from its middle; said two bevel portions mutually symmetrical are formed at their respective upper areas fulcrums;
wherein said shaft of said rotation axle is extended into said two forked spring tubes and said assembling portion, by tight enveloping of said assembling portion over a surface of said shaft, said rotation axle holds and positions said foldable screen at any desired angular position relative to said main body.

5. The hinge with forked spring tubes as claimed in claim 4, wherein said shaft of said rotation axle is provided with a plurality of oil ducts.

6. The hinge with forked spring tubes as claimed in claim 4, wherein said annular slipping over portion of each of said forked spring tubes is provided on its inner wall with a plurality of oil ducts.

7. The hinge with forked spring tubes as claimed in claim 6, wherein said oil ducts provided on said inner wall of said annular slipping over portion of each of said forked spring tubes basically are in an “X” shape, and three short oil ducts are provided respectively at a left side, a right side and an upper middle of said “X” shape.
